(19) United States
(12) Patent Application Publication
(10) Pub. No.: US 2023/0113837 A1
(43) Pub. Date: Apr. 13, 2023

(54) PEF COOKING DEVICE AND METHOD FOR APPLYING PEF PULSES

(71) Applicant: BSH Hausgeräte GmbH, Munich (DE)

(72) Inventors: Uwe Has, Unterneukirchen (DE); Bernhard Koch, Inzell (DE)

(21) Appl. No.: 17/795,889

(22) PCT Filed: Mar. 3, 2021
(86) PCT No.: PCT/EP2021/055266

§ 371 Date: Jul. 28, 2022

(30) Foreign Application Priority Data
Mar. 19, 2020 (DE) 10 2020 203 517.2

(51) Int. Cl. F24C 7/00; H05B 6/62; H05B 6/52; H05B 6/50; A23L 5/10; F24C 7/06

(52) U.S. Cl. CPC F24C 7/008; H05B 6/62; H05B 6/52; H05B 6/50; A23L 5/15; F24C 7/06

(57) ABSTRACT

A PEF cooking appliance includes a container for food to be cooked. The container includes two PEF electrodes which are spaced apart from one another and between which food to be cooked can be poured. A power factor correction filter is connected to a supply voltage and configured to generate a pulse voltage greater than 600 V, and an energy storage apparatus is connected to the power factor correction filter. Connected to energy storage apparatus are wo pulse forming apparatuses such that a first one of the two pulse forming apparatuses is connected to a first one of the two PEF electrodes and a second one of the pulse forming apparatuses is connected to a second one of the two PEF electrodes.

The invention relates to a PEF cooking appliance having a container for food to be cooked, said container having two PEF electrodes spaced apart from one another between which food to be cooked can be poured. The invention also relates to a method for applying PEF pulses to PEF electrodes of a PEF cooking appliance. In particular, the invention can be used advantageously for household PEF cooking appliances.

PEF (“pulsed electric field”) cooking, in other words cooking food to be cooked or foodstuffs by means of pulsed voltage pulses (“PEF pulses”) is fundamentally known. In doing so, the PEF pulses are applied to planar PEF electrodes of a container for food to be cooked that on the basis of the PEF electrodes coming into contact with the content of the container for food to be cooked generate an electrical current through the content of the container for food to be cooked. The content comprises typically liquid food to be cooked such as soup or food to be cooked that has been placed in a water bath. The generated current also flows through the food to be cooked, whereby it is cooked.

The current distributes itself ideally in a homogenous manner in the container for food to be cooked. However, this only applies if the conductivity of the liquid corresponds precisely to the conductivity of the food to be cooked. In the practical case, the conductivity of the liquid does however only rarely correspond to the conductivity of the food to be cooked. In addition, the conductivities can constantly change during the preparation because the food to be cooked discharges some salt into the water, for example. Also, some water can pass into the food to be cooked by osmosis. It is therefore generally necessary to anticipate localized inhomogeneities in the power density. In the extreme case, this can result in heat-induced changes in the food to be cooked. This particularly applies if the food to be cooked such as meat or a sausage product come into contact with the plates and in doing so is located in a liquid (in particular in water) that has a comparatively low conductivity. In this case, particularly high current densities can occur on the contact surface where they undesirably overcook the food to be cooked.

The food to be cooked can be prevented from contacting the contact plates by plastic sieves that are arranged in front of the contact plates or by other non-conductive spacers or by using baskets that can be inserted into the container for food to be cooked. However, this disadvantageously reduces the size of the useable volume available in the container for food to be cooked for receiving the food to be cooked.

WO 2016/008866 A1 relates to a method for PEF (“pulsed electric field”) cooking a food product in a treatment chamber, wherein the treatment chamber comprises two opposite-lying walls that each form one electrode. The method comprises the following steps: (a) placing a quantity of the food product, possibly in a surrounding liquid, in the treatment chamber between the two electrodes, with the result that the food product and/or the surrounding liquid are in direct contact with the electrodes; and (b) applying electrical pulses, which are generated by a pulsed electric field generator, to the electrodes, with the result that the food product is exposed to a pulsed electric field having a field strength of 10 to 180 V/cm and the total cooking time amounts to 0.5 to 1000 s. It is preferred that the number of pulses amounts to 1 to 2,000,000 and the pulses each have a duration of 1 to 20000 microseconds. The food product and, if present, the surrounding liquid have an electrical conductivity of 0.01 to 10 S/m. WO 2016/008868 A1 also relates to a cooking system that is suitable for cooking a food product in accordance with such a method. It has the disadvantage that the cooking system is designed in particular for voltage values of less than 600 V in order to keep the field generator and the associated connection simple. However, this also necessitates in a disadvantageous manner the use of comparatively small handling chambers that only render possible simple preparation processes involving foodstuffs.

It is the object of the present invention to overcome at least in part the disadvantages of the prior art and in particular to provide a possibility for PEF cooking that also renders possible more complex preparation processes involving food to be cooked, especially also involving large items of food to be cooked and/or involving multiple types of different food to be cooked at the same time, in a particularly user-friendly manner.

This object is achieved in accordance with the features of the independent claims. Advantageous embodiments are the subject matter of the dependent claims, the description and the drawings.

The object is achieved by a PEF cooking appliance, having

a container for food to be cooked having two PEF electrodes spaced apart from one another between which food to be cooked can be poured,

a power factor correction filter that can be connected to a supply voltage,

an energy storage apparatus that is connected to the power factor correction filter;

two pulse forming apparatuses that are connected to the energy storage apparatus and of said two pulse forming apparatuses a first pulse forming apparatus is connected to a first PEF electrode and a second pulse forming apparatus is connected to a second PEF electrode,

wherein

the power factor correction filter is configured so as to generate pulse voltages greater than 600 V, in particular of 625 V or more.

This PEF cooking appliance provides the advantage that it provides a reliable and cost-effective possibility to increase a voltage level of the PEF pulses that can be applied to the PEF electrodes greater than hitherto usual values of below 600 V. As a result, it is possible in turn to maintain the electric field strengths in the container for food to be cooked also in the case of larger containers for food to be cooked than hitherto. This relates to the consideration that if a spacing is increased between the PEF electrodes, at a given pulse voltage the electric field strength and consequently the power density between the PEF electrodes reduces and as a result also the total power that can be converted in the food to be cooked. By virtue of an enlarged container for food to be cooked, in turn the probability reduces that the food to be cooked comes into contact with the PEF electrodes, in particular in comparison to a crowded arrangement in baskets. In addition, this generates an advantageous effect that the current is distributed more uniformly in the container for food to be cooked, as a result of which the uniformity of the cooking result can be improved.

The PEF cooking appliance is used to cook or warm up food to be cooked that has been poured into the container for food to be cooked and this is referred to below collectively by the term “cook”. The PEF cooking appliance can be designed as a household PEF cooking appliance.

The container for food to be cooked can be installed in a fixed manner in the PEF cooking appliance or alternatively can be removed on the user side.

It is a development that the PEF electrodes are embedded in opposite-lying wall sections of the container for food to be cooked.

It is one embodiment that at least one of the PEF electrodes is arranged or can be arranged spaced apart from the wall of the container for food to be cooked, in particular with a spacing that can be adjusted—for example manually or in a motorized manner—with respect to the wall. This renders it possible in particular in the case of a small quantity of food to be cooked to provide an increased field strength and consequently quicker PEF cooking.

The food to be cooked can be poured into the container for food to be cooked without the further addition of a liquid, in particular water, for example a soup. However, in particular, it is also possible to pour a solid food to be cooked into the container for food to be cooked with the addition of a liquid, in particular water and said solid food to be cooked is then lying in a liquid bath.

The PEF electrodes can electrically contact the content of the container for food to be cooked (food to be cooked or food to be cooked/liquid). They are designed in particular in a plate-shaped manner and can then also be described as “contact plates”. In general, it is possible for more than two PEF electrodes to be provided in the container for food to be cooked, in particular two or more pairs of respective two PEF electrodes.

The—active or passive—power factor correction filter (“power factor correction”, PFC) is used so as to increase a power factor of an AC supply voltage that is applied thereto. The power factor correction filter is especially configured so as to upwards convert the AC supply voltage or its peak value to a higher value that corresponds in particular to a pulse voltage of the PEF pulse. The supply voltage can be a mains voltage, for example with a peak value of 110 V or 230 V.

The power factor correction filter is configured so as to generate pulse voltages greater than 600. It is one development that the power factor correction filter is configured so as to only generate pulse voltages of 600 V or more. It is one development that the power factor correction filter is in addition configured so as to generate pulse voltages of less than 600 V.

It is one development that the power factor correction filter is configured so as to generate maximum pulse voltages of 625 V or more, in particular of at least 650 V.

The energy storage apparatus that is connected to the power factor correction filter is used as an energy source for the voltage pulses or PEF pulses. The energy storage apparatus is charged via the output voltage of the power factor correction filter and thus stores such an amount of electrical energy that, during the subsequent pulse formation, electrical currents can be provided that are considerably greater than the maximum admissible loading of the energy supply.

It is one development that the energy storage apparatus has at least one capacitor that is connected to the output voltage of the power factor correction filter, advantageously multiple capacitors.

The pulse forming apparatuses are used so as to convert the pulse voltage that is provided by the energy storage apparatus into PEF pulses that can be applied to the respective PEF electrode. The controlling of an amount of energy that is currently to be introduced into the food to be cooked therefore takes place via the electrical energy of the PEF pulses. It is fundamentally possible for this purpose to adjust for example a duty cycle, a pulse duration, a period duration/pulse frequency of the pulses, or similar, for example in a similar manner to a pulse duration modulation. The pulse forming apparatuses do not perform in particular a pulse amplitude modulation. In particular, the PEF pulses can be applied with an alternating or commutating polarity to the PEF electrodes with the result that the applied pulse voltage signal corresponds to a pulsed AC voltage.

It is one advantageous embodiment in particular for a pulse generation that is particularly simple to implement that the PEF cooking appliance is configured, in order to control an amount of energy that is currently to be introduced into the food to be cooked, to adjust exclusively a pulse frequency of PEF pulses that are generated by the pulse forming apparatuses. In doing so, the pulse duration of the PEF pulses therefore remains constant. This can be realized by a corresponding activation of the pulse forming apparatuses.

It is possible using the PEF cooking appliance to realize pulse frequencies greater than 17 kHz without experiencing any problems. The pulse duration of the PEF pulse can therefore be considerably shorter than 100 microseconds, for example.

The pulse forming apparatuses are configured or can be activated in particular so as to apply a pause between sequential PEF pulses during which voltage is not applied to the PEF electrodes.

For generating advantageously short PEF pulses, the pulse forming apparatuses have in each case one or more, in particular in each case two, electronic switches such as IGBTs, thyristors etc.

It is one embodiment that the pulse forming apparatuses each have connections for supplying electrical energy from the energy storage apparatus (in other words voltage supply connections that are connected to the energy storage apparatus), wherein two electronic switches are connected between the connections. The switches can be activated in such a manner that the PEF electrode, which is connected to the associated pulse forming apparatus, can be connected in a pulsed manner, for example clocked, as desired to a first side or a first connection of the energy storage apparatus or to a second side or a second connection of the energy storage apparatus. The electronic switches can be in particular semiconductor switches such as transistors, MosFETs, IGBTs, triacs, thyristors etc.

However, it is fundamentally also possible that a pulse forming apparatus in a functionally similar manner has only one electronic switch.

It is one embodiment that the electronic switch is present in the form of thyristors and an anode connection of a first thyristor is connected to one of the two connections and a cathode connection of the second thyristor is connected to the other of the two connections, the cathode connection of the first thyristor is connected to the anode connection of the second thyristor, an outlet connection that leads to a respective PEF electrode is embodied as a center tap between the cathode connection of the first thyristor and the anode connection of the second thyristor and gates or activation connections of the thyristors can be activated by means of a control apparatus via respective activation lines.

The advantage is thus realized that it is possible to generate short PEF pulses in a reliable and cost-effective manner even in the case of high pulse voltages greater than 600 V.

It is an advantageous embodiment for configuring the power factor correction filter in a particularly simple and cost-effective manner that the pulse voltage that is output by the power factor correction filter is predetermined as a fixed value. In other words, the power factor correction filter is configured so as to output a output voltage that is predetermined in a fixed manner.

It is one embodiment that the pulse voltage that is output by the power factor correction filter can be adjusted in multiple steps. In other words, the power factor correction filter is configured so as to output multiple output voltage as desired. The differences of the pulse voltages of the different steps with respect to the still simple and cost-effective embodiment are rather great. They can be for example at least 25 V, particularly advantageously 50 V or greater. In one variant, it is possible using the power factor correction filter to output or adjust for example pulse voltages of 650 V, 700 V, 750 V etc.

It is one embodiment that the first pulse forming apparatus is connected to the first PEF electrode via a resistor (“pre-resistor”). The pre-resistor is used advantageously to limit the maximum occurring current. A further advantage is that it is possible by measuring a voltage drop at the pre-resistor, whose ohmic resistance is known very precisely, to estimate the amount of the through-flowing current that corresponds to the current flowing through the container for food to be cooked. The specific current value can in turn be used for example to monitor the cooking process, to detect imminent short circuits or short circuits that have occurred in the container for food to be cooked, to adjust or control in a closed loop manner the energy that is introduced into the container for food to be cooked by the electrical energy of the PEF pulses etc.

It is one embodiment that the PEF cooking appliance is configured so as to apply PEF pulses, which are generated by the pulse forming apparatuses, in a commutating manner to the PEF electrodes. This can be understood to mean that the PEF pulses are applied with alternating different polarity to the PEF electrodes. This can be implemented for example by activating the pulse forming apparatuses in a corresponding manner.

The object is achieved by a method for applying PEF pulses to the PEF electrodes, wherein

a supply voltage is upwards converted to a pulse voltage by means of the power factor correction filter,

an energy storage apparatus is charged by means of the pulse voltage;

the pulse voltage that is provided by the energy storage device in converted into PEF pulses of a value greater than 600 V and

the PEF pulses are applied to the PEF electrodes.

The method can be embodied in a similar manner to the PEF cooking appliance and has the same advantages.

The above described characteristics, features and advantages of this invention and the manner in which they are realized become clearer and more easily understood in conjunction with the following schematic description of an exemplary embodiment that is further explained in conjunction with the drawings.

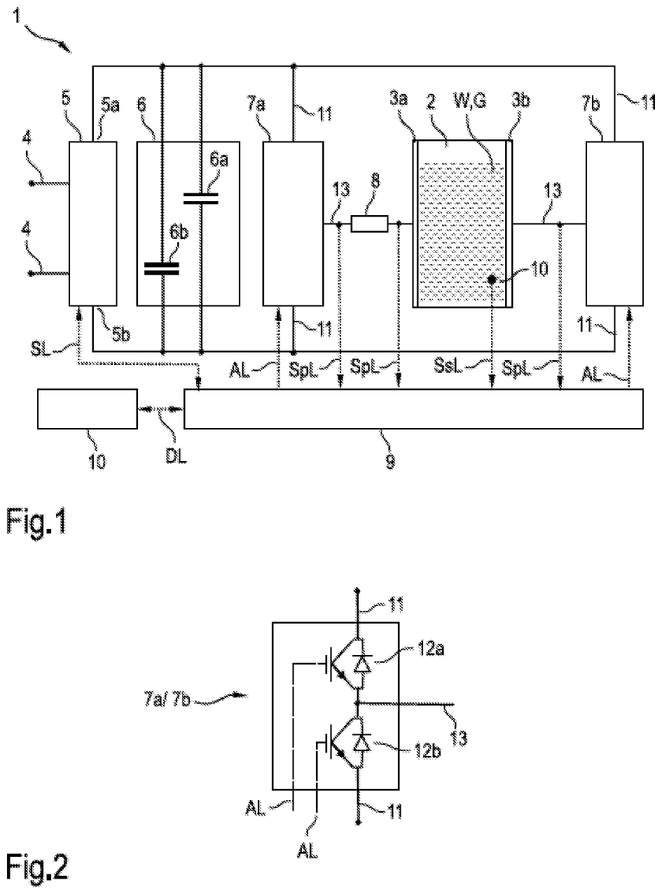

FIG. 1 shows a simplified diagram of a PEF cooking appliance according to the invention; and

FIG. 2 shows a circuit diagram of pulse forming apparatuses of the PEF cooking appliance from FIG. 1 in accordance with a possible exemplary embodiment.

FIG. 1 shows a simplified diagram of a PEF cooking appliance 1. The PEF cooking appliance 1 has a container 2 for food to be cooked that has a planar first PEF electrode 3a and a planar second PEF electrode 3b that in this case are spaced apart from one another. The container 2 for food to be cooked can be filled for example with water W and food G to be cooked that is located between the PEF electrodes 3a, 3b. It is possible to apply to the PEF electrodes 3a, 3b pulsed PEF voltage signals or PEF pulses which in a fundamentally known manner cause current to flow through the food G to be cooked in order to cook said food (i.e. to cook or warm up said food etc.)

Moreover, the PEF cooking appliance 1 has a power factor correction filter 5 that can be connected via supply connections 4 to a supply voltage (for example a mains voltage of 230 V, for example). The power factor correction filter 5 comprises in this case for example an upwards converter (not illustrated) that generates a pulse voltage. The pulse voltage is always greater than the peak voltage of the voltage supply. A mains filter (not illustrated) and the upwards converter avoid the transmission of line-related interference.

The value of the pulse voltage is greater than 600 V. It is predetermined as a fixed value in one variant. Alternatively, the pulse voltage can be adjusted in comparatively rough steps, for example of 650 V, 700 V, 750 V etc. This comparatively rough variance renders it possible to adjust the power factor correction filter to the impedance of the container 2 for food to be cooked or its content W, G, said impedance being typically only predictable to a very limited extent.

In this case, an energy storage apparatus 6 is connected at the outputs 5a, 5b to in this case for example two capacitors 6a, 6b which represent an energy source for generating the PEF pulses. The capacitors 6a, 6b are charged via the output voltage of the power factor correction filter 5 and store such an amount of energy that, during a subsequent pulse formation, currents can be provided that are greater than the maximum admissible loading of the power factor correction filter 5.

In turn, a first pulse forming apparatus 7a and a second pulse forming apparatus 7b are connected to the energy storage apparatus 6 and said pulse forming apparatuses convert the pulse voltage that is provided by the energy storage apparatus 6 to PEF pulses. The first pulse forming apparatus 7a is connected to the first PEF electrode 3a via an ohmic resistor (“pre-resistor”) 8, whereas the second pulse forming apparatus 7b is connected without a pre-resistor to the second PEF electrode 3b.

The pre-resistor 8 is used to delimit the maximum occurring current. Furthermore, it is possible by measuring a voltage drop at the resistor to estimate the amount of the current that is flowing through and consequently the amount of the current that is flowing through the container for food to be cooked 2.

The pulse voltage is applied in a commutating manner to the PEF electrode 3b by means of the pulse forming apparatuses 7a and 7b. This is understood to mean that in an alternating manner for respectively one pulse duration (a) a PEF pulse is applied to the first PEF electrode 3a by the first pulse forming apparatus 7a, whereas a PEF pulse of a different polarity is applied to the second PEF electrode 3b by the second pulse forming apparatus 7b and (b) a PEF pulse is applied to the second PEF electrode 3b by the first pulse forming apparatus 7a, whereas a PEF pulse of a different polarity is supplied to the first PEF electrode 3b by the second pulse forming apparatus 7b. In so doing, a pause is advantageously provided between two successive pulses.

The amount of energy that is currently to be introduced into the food G to be cooked is controlled exclusively via the pulse frequency of the PEF pulses, in particular at a pulse frequency greater than 17 kHz. The pulse duration can then be considerably shorter than 100 microseconds, for example.

Furthermore, the PEF cooking appliance 1 has a control apparatus 9 for the activation or closed loop control of the power factor correction filter 5 (in particular in the event that its pulse voltage can be adjusted in steps) and of the pulse forming apparatuses 7a and 7b and for receiving and processing measurement signals. For example, it is possible to output control signals to the power factor correction filter 5 by means of the control apparatus 9 via a line (“control line” SL) and receive measurement signals and/or data from the power factor correction filter 5. Activation signals are output to the pulse forming apparatuses 7a and 7b via in each case one or multiple activation lines AL. In addition, the control apparatus 9 can tap electrical voltages at the pre-resistor 8 and at the second PEF electrode 3b via voltage lines SpL, for example for monitoring a current and for voltage monitoring. For example, on account of the very precisely known resistance value of the pre-resistor 8, it is possible to conclude from the voltage that is applied at the pre-resistor 8 the through-flowing current. Furthermore, the control apparatus 9 can be connected via sensor lines SsL to one or multiple sensors 10, in this case, for example a temperature sensor in the container 2 for food to be cooked. The signals that are received for example via the lines SL, SpL and/or SsL can be used by the control apparatus 9 so as to monitor the functions of the PEF cooking appliance 1 and the preparation of the food G to be cooked and where appropriate to adapt the activation of the power factor correction filter 5 and/or of the pulse forming apparatuses 7a, 7b.

Moreover, the control apparatus 9 can be connected via a data line DL to a user interface 10 via which for example a user can provide input regarding desired cooking parameters and/or via which user instructions can be output.

The PEF cooking appliance 1 renders it possible on account of its construction to generate in a cost-effective manner voltage pulses of values greater than 600 V, in particular also noticeably greater than 600 V, for example of 700 V or more.

As a result, in turn the electric field strengths in the container 2 for food to be cooked can be maintained even in the case of larger dimensions of its useful volume than hitherto. In addition, by virtue of an enlarged container 2 for food to be cooked, the probability that food to be cooked comes into contact with the PEF electrodes is reduced, in particular in comparison to a crowded arrangement in baskets. This also produces the advantageous effect that a current is distributed more uniformly in the container 2 for food to be cooked, as a result of which the uniformity of the cooking result can be improved.

FIG. 2 shows a circuit diagram of a possible variant of the pulse forming apparatuses 7a, or 7b. The pulse forming apparatus 7a or 7b has connections 11 for supplying electrical energy from the energy storage apparatus 6. Two electronic switches, in this case in the form of a first thyristor 12a and a second thyristor 12b, are connected between the connections 11. In so doing, by way of example an anode connection of the first thyristor 12a is connected to one of the two connections 11 and a cathode connection of the second thyristor 12b is connected to the other one of the two connections 11. The cathode connection of the first thyristor 12a is connected to the anode connection of the second thyristor 12b. An outlet connection 13 that leads to the pre-resistor 8 or to the second PEF electrode 3b is formed as a center tap between the cathode connection of the first thyristor 12a and the anode connection of the second thyristor 12b. The gates of the first thyristor 12a and of the second thyristor 12b can be activated by means of the control apparatus 9 via respective activation lines AL with the result that the thyristors 12a, 12b can be switched by means of the control apparatus 9 as desired between blocking and conducting.

It goes without saying that the present invention is not limited to the illustrated exemplary embodiment.

In general, “a” or “an” can be understood to mean a single number or a plurality, in particular in the sense of “at least one” or “one or more” etc. as long as this is not explicitly excluded, for example by the expression “precisely one” etc.

Also, a number specification can comprise precisely the quoted number and also a usual tolerance range as long as this is not explicitly excluded.

### LIST OF REFERENCE CHARACTERS

1 PEF cooking appliance
2 Container for food to be cooked
3a First PEF electrode
3b Second PEF electrode
4 Supply connection
5 Power factor correction filter
6 Energy storage apparatus
6a Capacitor
6b Capacitor
7a First pulse forming apparatus
7b Second pulse forming apparatus
8 Pre-resistor
9 Control apparatus
10 User interface
11 Connection
12a First thyristor
12b Second thyristor
13 Output connection
AL Activation line
DL Data line
G Food to be cooked
W Water
SL Control line
SpL Voltage line
SsL Sensor line

1-11. (canceled)

12. A PEF cooking appliance, comprising:
a container for food to be cooked, said container including two PEF electrodes which are spaced apart from one another and between which food to be cooked can be poured;
a power factor correction filter connected to a supply voltage and configured to generate a pulse voltage greater than 600 V;
an energy storage apparatus connected to the power factor correction filter; and
two pulse forming apparatuses connected to the energy storage apparatus such that a first one of the two pulse forming apparatuses is connected to a first one of the two PEF electrodes and a second one of the pulse forming apparatuses is connected to a second one of the two PEF electrodes.

13. The PEF cooking appliance of claim 12, wherein the power factor correction filter generates a pulse voltage of 625 V or more.

14. The PEF cooking appliance of claim 12, wherein the pulse voltage that is output by the power factor correction filter is predetermined as a fixed value.

15. The PEF cooking appliance of claim 12, wherein the power factor correction filter is configured to output different pulse voltages greater than 600 V in multiple steps.

16. The PEF cooking appliance of claim 12, wherein each of the two pulse forming apparatuses includes two electronic switches.

17. The PEF cooking appliance of claim 16, wherein each of the two pulse forming apparatuses includes connections for supplying electrical energy from the energy storage apparatus, with the two electronic switches being embodied as thyristors and connected between the connections such that an anode connection of a first one of the thyristors is connected to one of the connections and a cathode connection of a second one of the thyristors is connected to another one of the connections, and a cathode connection of the first one of the thyristors is connected to an anode connection of the second one of the thyristors, and further comprising:
an outlet connection leading to a respective one of the two PEF electrodes and embodied as a center tap between the cathode connection of the first one of the thyristors and the anode connection of the second one of the thyristors; and
a control apparatus configured to activate gates of the thyristors via respective activation lines.

18. The PEF cooking appliance of claim 12, further comprising a pre-resistor via which the first one of the two pulse forming apparatuses is connected to the first one of the PEF electrodes.

19. The PEF cooking appliance of claim 12, wherein the pulse forming apparatuses generate PEF pulses applied in a commutating manner to the PEF electrodes.

20. The PEF cooking appliance of claim 12, wherein the pulse forming apparatuses generate PEF pulses having a pulse frequency which is exclusively adjusted to control an amount of energy that is currently to be introduced into the food to be cooked.

21. The PEF cooking appliance of claim 12, wherein the pulse forming apparatuses generate PEF pulses with a pulse duration of less than 100 microseconds.

22. The PEF cooking appliance of claim 12, wherein at least one of the two PEF electrodes has a spacing that is adjustable with respect to a wall of the container for food to be cooked.

23. A method for applying PEF pulses to PEF electrodes of a PEF cooking appliance which PEF electrodes are arranged spaced apart from one another in a container for food to be cooked, said method comprising:
upwardly converting by a power factor correction filter of the PEF cooking appliance a supply voltage to a pulse voltage;
charging an energy storage apparatus of the PEF cooking appliance with the pulse voltage;
converting the pulse voltage provided by the energy storage apparatus into PEF pulses of a value greater than 600 V; and
applying the PEF pulses to the PEF electrodes.
